(19) United States
(12) Patent Application Publication
(10) Pub. No.: US 2017/0207983 A1
(43) Pub. Date: Jul. 20, 2017

(54) MANUFACTURING EXECUTION SYSTEM

(71) Applicants: BOE TECHNOLOGY GROUP CO., LTD., Beijing (CN); ORDOS YUANSHENG OPTOELECTRONICS CO., LTD., Ordos (CN)

(72) Inventor: Xiaohua ZHANG, Beijing (CN)

(21) Appl. No.: 15/333,512

(22) Filed: Oct. 25, 2016

(30) Foreign Application Priority Data
Jan. 18, 2016 (CN) 201610031265.7

(51) Int. Cl. H04L 12/24; H04L 29/08; H04L 29/06

(52) U.S. Cl. CPC H04L 41/32; H04L 67/42; H04L 67/142

(57) ABSTRACT

A manufacturing execution system, comprising a plurality of process devices, at least one client terminal device, and a server, wherein the client terminal device is configured to send management information for instructing the process devices to perform production operation to the server; the process devices is configured to send production information reflecting the production operation performed thereby to the server; the server is configured to process the received management information, and send the processed management information to the corresponding process devices to perform the production operation; and the server is configured to process the received production operation and send the processed production operation to the corresponding client terminal device. The practicability and the production efficiency of the manufacturing execution system are improved.

### TECHNICAL FIELD

The embodiments of the present disclosure relate to a manufacturing execution system.

### BACKGROUND

A manufacturing execution system (MES) is a production information management system oriented to a workshop execution level of a manufacturing enterprise. The MES can provide the enterprise with management services including manufacturing data management, planning and scheduling management, production dispatching management, inventory management, quality management, human resource management, working center/device management, tool and fixture management, purchasing management, cost management, project dashboard management, production process control, underlying data integration analysis, upper layer data integrated decomposition, etc., and can build a solid, reliable, comprehensive and practical manufacturing coordinated management platform for the enterprise.

In the current MES, dedicated staffs must be assigned to perform monitoring and managing; therefore, for the workshop managing, it is limited to a certain extent and is not flexible. Furthermore, when a process device is failed or a certain production operation is completed, analysis and confirmation can not be done only based on production information reported by the process device, usually, it is necessary to designate technicians to the place where the process device is located to check in site, therefore, operation is complex, and hence operation efficiency is degraded. Moreover, considering that the process device is generally provided in a clean room, cleanness of the environment where the process device is located would be certainly affected by frequent walking around of the technicians.

### SUMMARY

According to at least one embodiment of this disclosure, a manufacturing execution system is provided, comprising a plurality of process devices, at least one client terminal device, and a server, wherein the client terminal device is configured to send management information for instructing the process devices to perform production operation to the server; the process devices is configured to send production information reflecting the production operation performed thereby to the server; the server is configured to process the received management information, and send the processed management information to the corresponding process devices to perform the production operation; and the server is configured to process the received production operation and send the processed production operation to the corresponding client terminal device.

### BRIEF DESCRIPTION OF THE DRAWINGS

In order to more clearly describe the technical solution of the embodiments of the present invention, the attached drawings for the embodiments will be briefly described, it is obvious that the attached drawings in the following description only illustrate some embodiments of the present invention, Based on the illustrated figures herein, those skilled in the art can obtain other figure(s), without any inventive work.

FIG. 1a is a first schematic diagram showing structure of a manufacturing execution system provided by embodiments of the present disclosure.

FIG. 1b is a second schematic diagram showing structure of a manufacturing execution system provided by embodiments of the present disclosure;

FIG. 2a is a third schematic diagram showing structure of a manufacturing execution system provided by embodiments of the present disclosure; and

FIG. 2b is a fourth schematic diagram showing structure of a manufacturing execution system provided by embodiments of the present disclosure.

### DETAILED DESCRIPTION

In order to make objects, technical details and advantages of the embodiments of the invention apparent, the technical solutions of the embodiments will be described in detailed way in connection with the drawings. Apparently, the described embodiments are just a part but not all of the embodiments of the invention. Based on the described embodiments herein, those skilled in the art can obtain other embodiment(s), without any inventive work, which should be within the scope of the invention.

Hereinafter, technical solutions related by the present disclosure will be described in detail by way of some particular embodiments thereof.

In a manufacturing execution system, its client terminal can be mounted on a computer device in a large device room, and is integrated with a plurality of management modules for performing the above described multiple management jobs. Since various data information of the MES is needed to be stored and recorded, and considering that management information sent by the client terminal can not be directly recognized and used by a process device, generally, the client terminal device integrated with the client terminal and process devices are connected with a switcher through interfaces in wired manner, then the switcher is connected with a server.

For example, when the client terminal device sends management information, the management information will be sent to the switcher and then is forwarded to the server by the switcher. On one hand, the management information can be processed by the server to interpret the same into management information recognizable by the process device; on the other hand, the management information can be stored into a database as history data information by the server.

For example, since the client terminal device is connected with the switcher by wires, the client terminal device can be located at a fixed position.

Wherein the manufacturing execution system can be configured in any existing process manufacturing workshop, and its application scenario is not limited by the present disclosure. Hereinafter, the present disclosure will be described mainly by taking the process manufacturing workshop related in a panel manufacturing industry as an example.

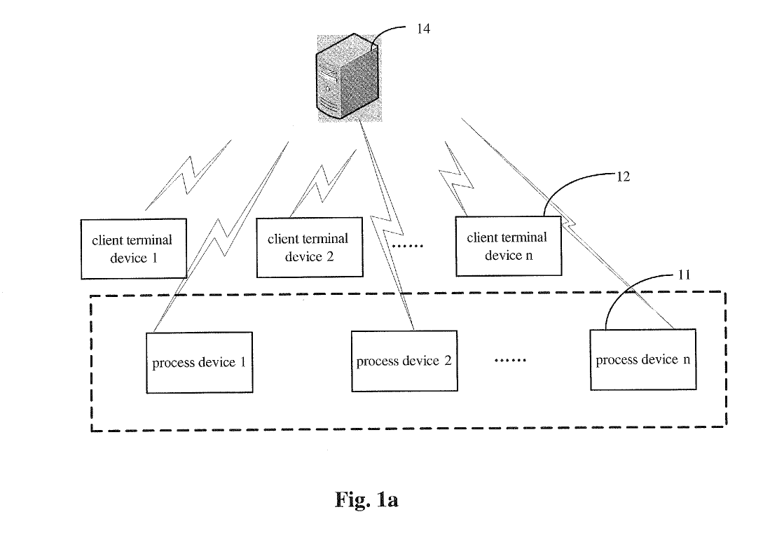

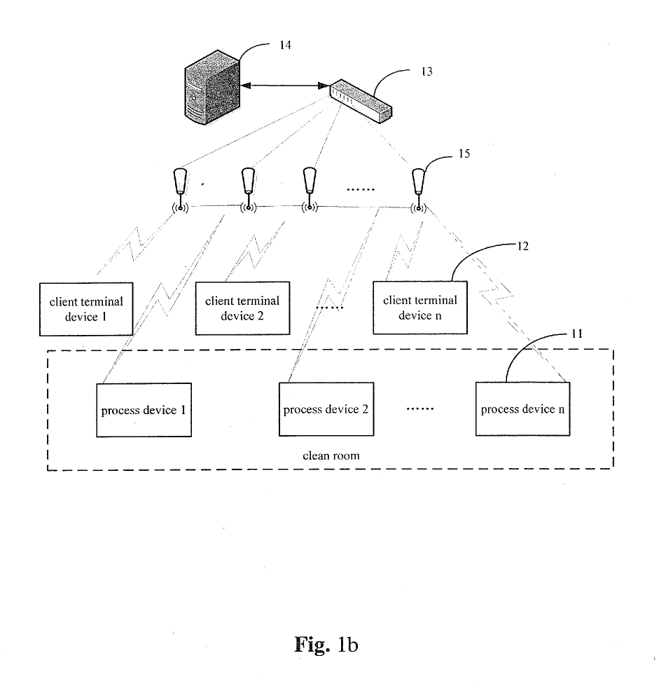

FIG. 1a is a schematic diagram showing structure of a manufacturing execution system provided by an embodiment of the present disclosure. Referring to FIG. 1a, according to an example of the present invention, the manufacturing execution system mainly includes a plurality of process devices 11, at least one client terminal device 12, and a server 14. The client terminal device 12 is configured to send management information instructing the process devices 11 to perform production operation to the server 14; the process devices 11 are configured to send production information reflecting the production operation performed by themselves to the server 14; the server 14 is configured to process the received management information, and send the processed management information to the respective process devices 11 to perform the production operation; and the server 14 is further configured to process the received production information, and send the processed production information to the respective client terminal devices 12.

According to an example of the present invention, the plurality of process devices 11 are provided inside a clean room, and the client terminal device 12 is movable between inside and outside of the clean room, and the server 14 is provided at outside of the clean room.

FIG. 1b is a schematic diagram showing structure of a manufacturing execution system provided by another embodiment of the present disclosure. Referring to FIG. 1b, the manufacturing execution system mainly includes a plurality of process devices 11, at least one client terminal device 12, a switcher 13, a server 14, and a plurality of wireless access devices 15 connected with the switcher 13 by a optical fiber link S1, wherein a wireless network established by the wireless access devices 15 covers the positions where the process devices 11 and the client terminal device 12 are located. The client terminal device 12 is configured to send management information for instructing the process devices to perform production operation to the switcher 13 through the wireless access devices 15, and the management information is forwarded to the server 14 by the switcher 13. The process devices 11 are configured to send production information reflecting the production operation performed by themselves to the switcher 13 through the wireless access devices 15, and the production information is forwarded to the server 14 by the switcher 13. The server 14 is configured to process the received management information, and send the processed management information to the switcher 13, and the processed management information is forwarded to the corresponding process devices 11 by the switcher 13 through the wireless access devices 15 to perform the production operation. The server 14 is further configured to process the received production information and send the processed production information to the switcher 13. The switcher 13 forwards the processed production information to the respective client terminal devices 12 through the wireless access devices 15.

According to an example of the present disclosure, the plurality of process devices 11 are provided inside a clean room, the client terminal device 12 can be movable between inside and outside of the clean room, and the switcher 13 and the server 14 are provided outside the clean room. The plurality of wireless access devices 15 are provided both inside and outside of the clean room, and form a wireless network covering the positions where the process devices 11 and the client terminal device 12 are located, so that any one of the process devices 11 and any one of the client terminal devices 12 can be connected with the network in time.

According to an example of the present invention, an identification of one corresponding process device is carried by the management information and/or the production information. Thus, in this system architecture, the client terminal device 12 is configured to send the management information for instructing the process devices 11 to perform the production operation to the switcher 13 through the wireless access devices 15, and is forwarded to the server 14 by the switcher 13, wherein the management information carries the identification of the corresponding process device. The server 14 is configured to process the received management information and send the processed management information to the switcher 13. The switcher 13 forwards the processed management information to a corresponding process device through the wireless access devices 15 according to the identification carried by the management information to perform the production operation. The process devices 11 are configured to send the production information reflecting the production operation performed by themselves to the switcher 13 through the wireless access devices 15, and is forwarded to the server 14 by the switcher 13, wherein the production information carries the identification of each of the process devices. The server 14 is configured to process the received production information and send the processed production information to the switcher 13, and the switcher 13 forwards the processed production information to a corresponding client terminal device through the wireless access device 15 according to the identification carried by the production information.

For example, each of the process devices 11 according to the present disclosure can be provided with a wireless communication module by which the process device can perform wireless communication with the wireless access devices.

With the above technical solution, wireless connection is used between the switcher and the respective process devices and between the switcher and the client terminal device, and the wireless access devices are used to build communication bridges between the respective process devices, the client terminal device and the switcher, therefore, the limitation due to the wired link can be avoided. Moreover, by wireless communication, it is unnecessary for the client terminal device to be at a fixed position, and can be carried by technicians so as to perform management operation at the process device's place or any other places covered by the wireless network, thus the applicability and operation efficiency can be improved.

Furthermore, the wireless access devices according to the present disclosure can be wireless hotspots or WIFI devices, and there is no limitation thereon. Also, each of the wireless access devices can be installed with a set of a message process unit and a forward unit for operating in connection with the manufacturing execution system. For example, in order to improve the reliability of the wireless network and avoid large area of interruption of the wireless communication link due to a certain node in a star link is failed, each of the wireless access devices can be connected with each other in a grid manner with optical fiber links therebetween. In addition, by connecting in this way, pressure on the main communication link can be alleviated. Moreover, the wireless networks established by each of the wireless access devices are overlapped with each other, thus, fully covering and high strength covering on the positions where the process devices and the client terminal device are located can be achieved.

For example, the wireless network established by the plurality of wireless access devices can employ WiFi operated under 2.4 GHz 802.11b/g protocol to establish a wireless network in a range of hundreds meters, and can also employ the technology such as 3G/4G/5G or ZigBee (based on IEEE 802.15.4—lower power consumption local network protocol) or HART (Highway Addressable Remote Transducer) to achieve wireless network communication.

Furthermore, for example, the wireless access devices are connected to the switcher by optical fiber links, and in the present disclosure, the switcher can be a dual computer dual link hot-standby backup switcher. Thus, in use, interruption of the system operation caused by transmission malfunction of the switcher can be avoided, the usage efficiency of the switcher can be improved, and a reliable support for the MES can be provided.

For example, the switcher is connected with the server through an optical fiber link, wherein the server according to the embodiment of the present disclosure is a dual computer hot-standby backup server.

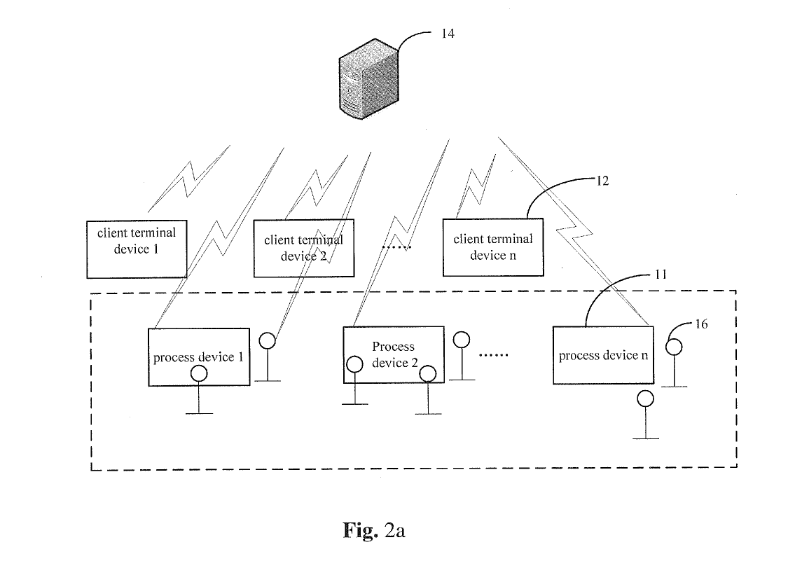

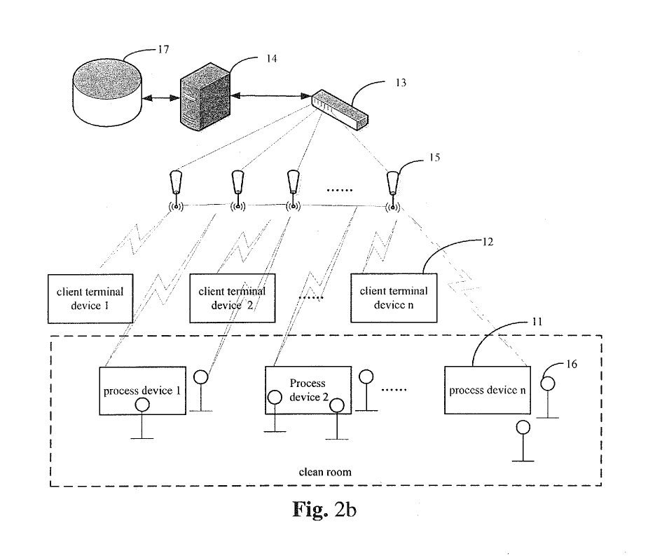

For example, in order to avoid the inconvenience that the technicians frequently go to the site to confirm the production operation state of the process devices and the disadvantage of poor efficiency, referring to FIG. 2a and FIG. 2b, the MES in the present disclosure further includes at least one image collecting device 16 provided for each of the process devices.

FIG. 2a is a schematic diagram showing structure of a manufacturing execution system provided by an embodiment of the present disclosure. Referring to FIG. 2a, the image collecting device 16 collects image information reflecting the production operation state of the corresponding process device 11 in real time, wherein the image collecting device 16 is configured to collect the image information reflecting the production operation state of a corresponding process device in real time and send the image information to the server 14.

FIG. 2b is a fourth schematic diagram showing structure of a manufacturing execution system provided by an embodiment of the present disclosure. Referring to FIG. 2b, the image collecting device 16 can further send the image information to the switcher 13 through the wireless access devices 15, and is forwarded to the server 14 by the switcher 13 to be stored.

According to an example, of the present invention, the image collecting device 16 is configured to collect the image information reflecting the production operation state of the corresponding process device 11, and forward the image information to the server 14 to be stored. For example, the image information is sent to the switcher 13 through the wireless access devices 15 and is forwarded to the server 14 by the switcher 13 to be stored. For example, the image information carries an identification of a corresponding process device.

According to another example of the present invention, the image collecting device 16 is configured to collect the image information reflecting the production operation state of the corresponding process device 11 in real time, and send the image information to a corresponding client terminal device to be displayed, according to the identification of the process device carried by the image information. For example, the image information is directly sent to the corresponding client terminal device to be displayed through the wireless access devices 15.

For example, the image collecting device can be provided at a critical position on the process device, for example, provided in an operation chamber or on an operation stage of the corresponding process device.

Furthermore, the image collecting device according to the present disclosure can be a wireless communication camera which is capable of transmitting the image information through the wireless network established by the wireless access devices.

For example, referring to FIG. 2b, the MES may further include a database 17. Thus, the server 14 is further configured to store the management information, the production information and the image information received thereby and belonging to the corresponding process devices into the database 17 as history data information. The database 17 can use a structured database, or can also use a non-structured big data database.

Furthermore, still referring to FIG. 2b, the client terminal device 12 may send enquiry information to the server 14, the server 14 retrieves data information corresponding to the corresponding process devices from the database 17 according to the enquiry information, and send the retrieved data information to the client terminal device 12. For example, the client terminal device 12 sends the enquiry information to the switcher 13 through the wireless access device 15, the enquiry information is forwarded to the server 14 by the switcher 13, and the enquiry information carries an identification of a corresponding process device. The server 14 retrieves the history data information corresponding to the corresponding process devices according to the identification carried in the received enquiry information, sends the retrieved history data information to the switcher 13, and is forwarded to the client terminal device 12 by the switcher 13 through the wireless access device 15.

From above solution, it can be seen that after the image collecting device is added in the MES, the image collecting device can collect the production operation state at the critical position of the process device, and directly feedback the image information to the client terminal device or stored in the database so as to be retrieved by the client terminal device. Thus, during the entire production operation, it is unnecessary for the technicians to frequently go to the place where the process device is located to confirm in site, human resource is saved, and at the same time, production efficiency is improved.

For example, referring to FIG. 2b, the client terminal devices 12 correspond to the process devices 11 in one to one correspondence, that is, one process device 11 is provided with one client terminal device 12, thus, it facilitates the technicians to monitor the production operation of a plurality of the process devices 11 at the same time, and hence determine how to manage the corresponding process devices. It is also desirable that a plurality of process devices are only provided with one client terminal device, in this case, when the technicians want to manage any one of the process devices, a client terminal management module corresponding to said one process device can be called, so as to enter a management interface for said one process device.

In the embodiment of the present disclosure, the process devices each is a dual communication module, that is, is equiped with a wireless communication module and a wired communication module at the same time. It is also practical that the wireless communication module is used to perform communication management service, and when signal strength of the wireless network is detected to be poor, communication is switched to the wired communication module so as to perform communication management service.

In addition, each of the client terminal devices can be equipped with a MES client terminal, when the technicians enter a control interface of the MES client terminal through the client terminal device, different operation menus can be called so as to enter control interfaces for different operation types. In particularly, the operation types include production scheduling, production operation, logistics management, device management, material management, warning management, information enquiry, and so on.

In the embodiments of the present disclosure, wired communication between the switcher and the respective process devices and between the switcher and the client terminal device is substituted with wireless communication, and the wireless access devices are used to build communication bridges between the respective process devices, the client terminal device and the switcher, therefore, the limitation due to the wired link can be avoided. Moreover, by wireless communication, it is unnecessary for the client terminal device to be at a fixed position, and can be carried by technicians so as to perform management operation at the process device's place or any other places covered by the wireless network, thus the applicability and operation efficiency can be improved. Moreover, by adding the image collecting devices in the MES, the image collecting device can collect the production operation state at the critical positions of the process devices, and directly feedback the image information to the client terminal device or stored in the database so as to be retrieved by the client terminal device. Thus, during the entire production operation, it is unnecessary for the technicians to frequently go to the place where the process device is located to confirm in site, human resource is saved, and at the same time, production efficiency is improved.

The skilled in the art know that the embodiments in the disclosure may be provided with method, system or computer program product. Therefore, the embodiments of this disclosure can be implemented by pure hardware embodiments, pure software embodiments or embodiments combined with software and hardware.

In the embodiments of the present invention, the modules may be achieved by software so as to be executed by various types of processors. For example, a marked executable code module may include one or more physical or logical blocks of a computer instruction, and for instance, may be constructed as an object, a procedure or a function. Even so, executable codes of the marked module are not required to be physically located together but may include different instructions stored on different physical blocks. When the instructions are logically combined, a module is constructed and the predetermined object of the module is achieved.

Actually, the executable code module may include a single instruction or many instructions which may even be distributed on a plurality of different code segments, distributed in different programs, and distributed on a plurality of storage devices. Similarly, operational data may be identified in the module, achieved by any appropriate means and organized in any appropriate type of data structure. The operational data may be collected as a single data set or may be distributed at different positions (including the case of being distributed on different storage devices) and may at least partially exist on a system or a network by being only taken as electronic signals.

When the module can be achieved by software, in view of the level of the traditional hardware technology, those skilled in the art can establish corresponding hardware circuits on modules capable of being achieved by software to achieve corresponding functions regardless of the cost. The hardware circuits include conventional very large scale integration (VLSI) circuits or gate arrays and conventional semiconductors such as logic chips and transistors or other discrete elements. The module may also be achieved by programmable hardware units such as field programmable gate arrays, programmable logic arrays and programmable logical devices.

Although some preferable embodiments of this disclosure have been described, however, those skilled in the art can make various modifications and variations to the embodiments when they know the common inventiveness concept. Thus, the attached claims should be interpreted to include the preferable embodiments and all the modifications and variations fall into the scope of this disclosure.

Apparently, the skilled person in the art can make all kinds of modifications and variations without being out of the spirit and scope of this disclosure. Thus, if these modifications and variations of this disclosure belong to the scope of the claims of the disclosure and the equivalent techniques, this disclosure intends to include these modifications and variations as well.

The present application claims the priority of Chinese Patent Application No. 201610031265.7 filed on Jan. 18, 2016, the Chinese Patent Application is entirely incorporated therein as a part of the present application by reference.

What is claimed is:

1. A manufacturing execution system, comprising a plurality of process devices, at least one client terminal device, and a server,
wherein the client terminal device is configured to send management information for instructing the process devices to perform production operation to the server;
the process devices is configured to send production information reflecting the production operation performed thereby to the server;
the server is configured to process the received management information, and send the processed management information to the corresponding process devices to perform the production operation; and the server is configured to process the received production operation and send the processed production operation to the corresponding client terminal device.

2. The system according to claim 1, further comprising a switcher and a plurality of wireless access devices connected with the switcher, wherein the wireless access devices establish a wireless network covering positions where the process devices and the client terminal device are located;
the client terminal device is further configured to send the management information for instructing the process devices to perform the production operation to the switcher through the wireless access devices, and is forwarded to the server by the switcher;
each of the process devices is further configured to send the production information reflecting the production operation performed thereby to the switcher through the wireless access devices, and is forwarded to the server by the switcher;
the server is further configured to process the received management information and send the processed management information to the switcher, and the switcher forwards the processed management information to the corresponding process device to perform the production operation through the wireless access devices; and
the server is further configured to process the received production information and send the processed production information to the switcher, and the switcher forwards the processed production information to the corresponding client terminal device through the wireless access devices.

3. The system according to claim 2, wherein the production information carries an identification for the process device, the management information carries an identification for the corresponding process device, the switcher forwards the management information to the corresponding process device to perform the production operation through the wireless access devices according to the identification carried by the management information, and the switcher forwards the production information to the corresponding client terminal device through the wireless access devices according to the identification carried by the production information.

4. The system according to claim 1, further comprising at least one image collecting device provided for each of the process devices,
wherein the image collecting device is configured to collect image information reflecting production operation state of the corresponding process device in real time and send the image information to the server.

5. The system according to claim 2, further comprising at least one image collecting device provided for each of the process devices,
wherein the image collecting device is configured to collect image information reflecting production operation state of the corresponding process device in real time and send the image information to the switcher, so that to be forwarded to the server by the switcher.

6. The system according to claim 1, further comprising at least one image collecting device provided for each of the process devices,
wherein the image collecting information is configured to collect image information reflecting production operation state of the corresponding process device in real time and send the image information to the client terminal device to be displayed.

7. The system according to claim 2, further comprising at least one image collecting device provided for each of the process devices,
wherein the image collecting information is configured to collect image information reflecting production operation state of the corresponding process device in real time and send the image information to the client terminal device through the wireless access devices to be displayed.

8. The system according to claim 4, wherein the image information carries an identification for a corresponding process device.

9. The system according to claim 4, wherein the image collecting device is provided in an operation chamber or on an operation stage of the process device.

10. The system according to claim 2, wherein the plurality of wireless access devices are connected with each other by optical links therebetween and in a grid manner.

11. The system according to claim 1, further comprising a database;
wherein the server is further configured to store the received management information, the received production information and the received image information belonging to a corresponding process device into the database as history data information.

12. The system according to claim 11, wherein the client terminal device is further configured to send enquiry information to the server, and the enquiry information carries an identification for a corresponding process device;
the server is further configured to retrieve the history data information correponding to a correponding process device from the database according to the identification carried by the received enquiry information, and send the retrieved histroy data information to the client terminal device.

13. The system according to claim 12, further comprising a switcher and a plurality of wireless access devices connected with the switcher, wherein the wireless access devices establish a wireless network covering positions where the process devices and the client terminal device are located;
wherein the client terminal device is further configured to send the enquiry information to the switcher through the wireless access devices, and the enquiry information is forwarded to the server by the switcher, the enquiry information carries an identification for a corresponding process device;
the server is further configured to retrieve the history data information corresponding to the corresponding process device from the database according to the identification carried in the received enquiry information, and send the retrieved history data information to the switcher to be forwarded to the client terminal device through the wireless access devices.

14. The system according to claim 1, wherein the client terminal devices correspond to the process devices in one to one correspondence, and each of the client terminal devices is configured to manage the production operation of the corresponding process device.

15. The system according to claim 14, wherein the client terminal devices are movable terminal devices.

16. The system according to claim 1, wherein the server is a dual computer hot-standby backup server.

17. The system according to claim 2, wherein the switcher is a dual computer dual link hot-standby backup switcher.
